(19) United States
(12) Patent Application Publication
(10) Pub. No.: US 2007/0179697 A1
(43) Pub. Date: Aug. 2, 2007

(54) Lane departure warning system and method

(75) Inventor: Gusztav Holler, Elyria, OH (US)

Correspondence Address: CALFEE HALTER & GRISWOLD, LLP, 800 SUPERIOR AVENUE, SUITE 1400, CLEVELAND, OH, 44114, US

(73) Assignee: BENDIX COMMERCIAL VEHICLE SYSTEMS LLC

(21) Appl. No.: 11/343,740

(22) Filed: Jan. 31, 2006

(51) Int. Cl. G06F 19/00

(52) U.S. Cl. 701/70; 701/301

(57) ABSTRACT

A vehicle lane departure warning system and method uses the vehicle braking system to provide tactile feedback to the driver. In one embodiment, one of the steerable road wheels of the vehicle is braked, to cause force to be transmitted back to the vehicle steering wheel, resulting in the driver receiving tactile feedback through the steering wheel.

### BACKGROUND

The present invention relates generally to a lane departure warning system and method. In particular, the present invention relates to a vehicle lane departure warning system and method that uses the vehicle braking system to provide tactile feedback to the driver.

Various lane departure warning systems have been developed. Such systems typically incorporate a lane departure sensor that provides an electrical signal in the event that the vehicle unintentionally departs from the intended path or track of travel, as measured or indicated by the lane markers on the roadway, for example. One known system responds to such a signal by pulsing the steering system to provide tactile feedback to the driver through the steering wheel.

### SUMMARY

In one aspect the invention relates to a method of providing a lane departure warning to a vehicle driver by tactile feedback through the vehicle steering wheel. The method includes the steps of sensing a lane departure of the vehicle; in response to the sensing step, applying braking force to a steerable road wheel of the vehicle; and transmitting force from the steerable road wheel to the vehicle steering wheel, thereby to provide tactile feedback through the steering wheel.

In another aspect the invention relates to apparatus for providing tactile feedback to a driver of a vehicle having left and right steerable road wheels and a steering wheel for controlling the steerable road wheels. The braking system includes a left brake associated with the left steerable road wheel, a right brake associated with the right steerable road wheel, and a brake pedal operable by a driver of the vehicle for applying the left and right brakes. The apparatus also includes a lane departure sensor, and an electronic control unit operatively connected with the lane departure sensor, the electronic control unit being operable to apply one of the left and right brakes in response to sensing an unintended lane departure of the vehicle without driver input through the brake pedal.

In another aspect the invention relates to apparatus usable in a vehicle braking system for providing tactile feedback to a driver of a vehicle having a steering wheel and left and right steerable road wheels. The apparatus includes a lane departure sensor, and an electronic control unit operatively connected with the lane departure sensor, the electronic control unit providing a control signal for controlling the vehicle brakes in response to sensing an unintended lane departure of the vehicle without driver input through the brake pedal.

In another aspect the invention relates to apparatus for providing a lane departure warning to a vehicle driver through tactile feedback in the vehicle steering wheel. The apparatus includes means for sensing an unintended lane departure of the vehicle, and means responsive to the means for sensing for applying braking force to a steerable road wheel of the vehicle, thereby to provide tactile feedback through the steering wheel.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of an embodiment of the invention, in block diagram form;

FIG. 2 is a schematic illustration showing a vehicle traveling on a roadway with lane departure indications; and

FIG. 3 is a flow chart illustrating a method that is an embodiment of the invention.

### DETAILED DESCRIPTION

The present invention relates generally to a lane departure warning system and method. In particular, the present invention relates to a vehicle lane departure warning system and method that uses the vehicle braking system to provide tactile feedback to the driver. The present invention is applicable to systems of varying constructions. As representative of the invention, FIG. 1 illustrates schematically a vehicle braking system 10 that is a first embodiment of the invention.

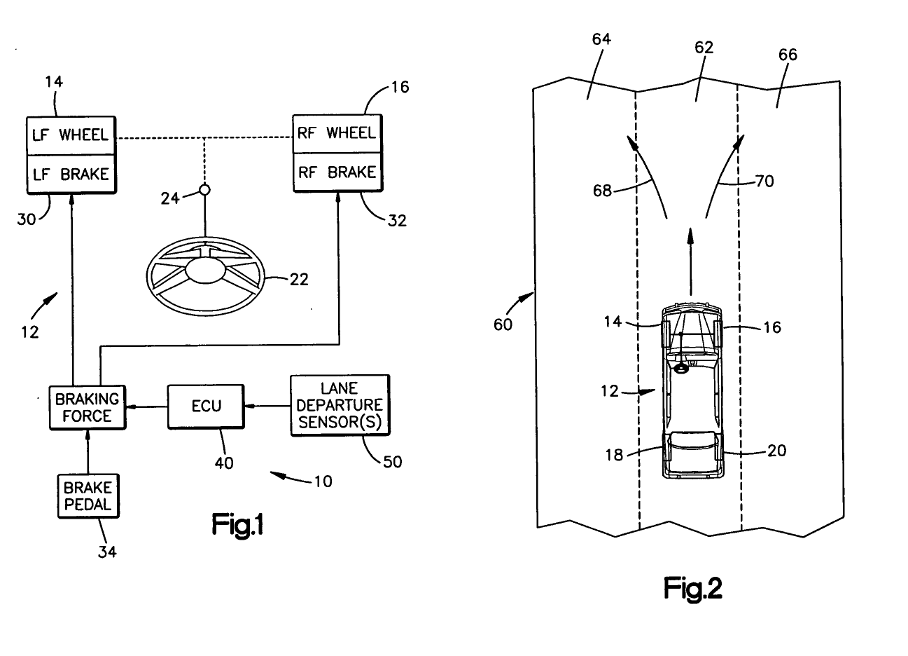

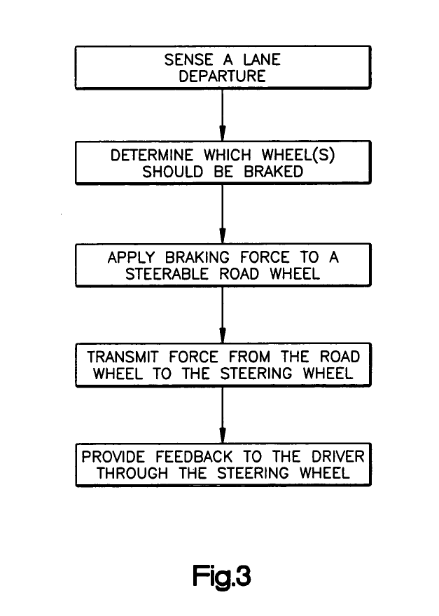

The system 10 is located on a vehicle 12 (FIGS. 1 and 2). The vehicle 12 is illustrated as having front wheels 14 and 16, and rear wheels 18 and 20. The invention is applicable to vehicles having different and varying types of wheel configurations, for example, a commercial vehicle such as a tractor, or a tractor-trailer combination, or a straight truck, or a bus. Each one of these types of vehicles has steerable road wheels, typically the front wheels of the vehicle. Thus, on the illustrated vehicle 12, the front wheels 14 and 16 are the left and right steerable road wheels of the vehicle.

The vehicle 12 has a steering wheel 22. The steering wheel 22 is rotatable by the vehicle driver to control the steering angle of the front wheels 14 and 16. A linkage of some type, indicated schematically at 24, connects the steering wheel 22 with the front wheels 14 and 16. The linkage 24 provides control force from the steering wheel 22 to the front wheels 14 and 16 and may include a power assist mechanism, for example.

The linkage 24 also provides feedback from the front wheels 14 and 16 to the steering wheel 22. Thus, for example, when one of the front wheels 14 and 16 hits a bump or a curb or starts to turn, that is sensed in the steering wheel 22 as a rotational force on the steering wheel not provided by the driver. Thus, tactile feedback is provided to the driver.

The braking system 10 may be a pneumatic braking system or a hydraulic braking system. In an embodiment for a large commercial vehicle, the braking system is typically a pneumatic braking system. The braking system 10 includes a left front brake, shown schematically at 30, that is associated with the left front wheel 14. The braking system 10 also includes a right front brake, shown schematically at 32, that is associated with the right front wheel 16. The braking system 10 also includes a brake pedal 34 by which the driver can cause braking force to be applied at the left front wheel 14 and the right front wheel of the vehicle 16.

The braking system 10 also includes an electronic control unit, or ECU, shown schematically at 40. The ECU 40 is capable of performing various functions in the braking system 10. For example, the ECU 40 is capable of causing the braking system to provide braking force to one or more of the wheels of the vehicle 12, without driver intervention via the brake pedal 34. The ECU 40 is capable of providing braking force to either one 14 or 16 of the front wheels of the vehicle 12, without providing braking force to the other one of the front wheels. Braking systems and ECUs of this type are found in different types of vehicle, for example in vehicles having electronic stability control.

The braking system 10 also includes a lane departure sensor, indicated schematically at 50, which is operatively connected to the ECU 40. The sensor that is shown at 50 may actually be one or more individual sensor units, and may be of any suitable type. The sensor 50 is operative to sense a lane departure. Specifically, the sensor 50 is operative to sense a departure from the intended lane of travel of the vehicle 12, either to the left or to the right. The sensor 50 in such a case outputs an appropriate signal to the ECU 40. Thus, the ECU 40 is provided with information indicating either a directionally left lane departure, or a directionally right lane departure.

FIG. 2 illustrates schematically a path of travel of the vehicle 12. The vehicle 12 is on a roadway 60 having three lanes, including a center lane 62, a left lane 64, and a right lane 66. The vehicle 12 is in the center lane 62 and is intended to be traveling along the center lane.

It is possible that the vehicle 12 might unintentionally move out of its intended path, or track, or lane, of travel, by departing from the center lane 62. For example, the vehicle 12 might experience a directionally left lane departure, as indicated by the arrow 68. Or, the vehicle 12 might experience a directionally right lane departure, as indicated by the arrow 70.

If a lane departure should occur, the lane departure sensor 50 outputs an appropriate signal to the ECU 40. The ECU 40 is thus informed of the fact of the lane departure. The ECU 40 is also informed of the direction of the lane departure, that is, a directionally left lane departure or a directionally right lane departure.

The ECU 40 is programmed to respond to the signal from the lane departure sensor 50. Specifically, the ECU 40 is programmed to provide a control signal so as to cause braking force to be applied to one of the front wheels 14 and 16, in response to the sensing of a lane departure. The ECU 40 can cause braking force to be applied to the right front wheel 16 or to the left front wheel 14. For reasons described below, it may be desirable to cause braking force to be applied to the front wheel 14 and 16 that is on the side of the vehicle 12 opposite to the direction of lane departure.

Braking force is preferably applied to only one of the front wheels 14 and 16, not to both front wheels simultaneously. When this occurs, the front wheel that is braked slows down compared to the non-braked front wheel. In addition, the steerable wheels 14 and 16 turn relative to the longitudinal central axis of the vehicle 12. For example, if the right front wheel 16 is braked, the front wheels 14 and 16 turn to the right by at least a small amount.

The turning of the steerable wheels 14 and 16 is felt, by transmission of force back up through the steering linkage 24, to the steering wheel 22. The braking of the one wheel thus causes force to be transmitted from the wheels 14 and 16, through the linkage 24, to the vehicle steering wheel 22. This force is felt as a turning moment on the steering wheel 22—the steering wheel tries to turn in the driver's hands. For example, if the right front wheel 22 is braked, the vehicle steering wheel 22 turns to the right by at least a small amount. This turning motion or force of the steering wheel 22 constitutes tactile feedback to the driver of the vehicle 12, through the steering wheel 22, in response to the sensing of the lane departure.

An added effect of the wheel braking is that the vehicle 12 might tend to turn back toward its intended path. For example, if a directionally left lane departure is sensed, the right front wheel 16 can be braked, causing the vehicle 12 to tend to turn toward the right, thus countering the lane departure. Alternatively, if a directionally right lane departure is sensed, the left front wheel 14 can be braked, causing the vehicle 12 to tend to turn toward the left, thus countering the lane departure. The ECU 40 can optionally be programmed to operate in this manner. The amount of braking force that is applied is, by design, either (a) sufficient to cause a significant departure from the path or track of the vehicle 12, or (b) not sufficient to cause a significant departure from the path or track of the vehicle.

In another embodiment, the ECU 40 can cause braking force to be applied in an alternating manner, first to one and then to the other of two steerable road wheels 14 and 16 of the vehicle 12. This type of application of braking force can cause the vehicle steering wheel 22 to oscillate in the driver's hands, as another form of tactile feedback to the driver in the event of an unintended lane departure.

From the above description of the invention, those skilled in the art will perceive improvements, changes, and modifications in the invention. Such improvements, changes, and modifications within the skill of the art are intended to be included within the scope of the appended claims.

Having described the invention, I claim:

1. A method of providing a lane departure warning to a vehicle driver, the method comprising the steps of:
sensing a lane departure of the vehicle; and
in response to the sensing step, applying braking force to a steerable road wheel of the vehicle.

2. A method as set forth in claim 1 wherein the vehicle has two steerable road wheels and the step of applying braking force to a steerable road wheel of the vehicle comprises applying braking force to only one of the two steerable road wheels of the vehicle.

3. A method as set forth in claim 2 wherein:
the step of sensing an unintended lane departure of the vehicle comprises sensing a direction of lane departure; and
the step of applying braking force to only one of the two steerable road wheels of the vehicle comprises applying braking force to a selected steerable road wheel to counter the direction of lane departure.

4. A method as set forth in claim 1 wherein the step of applying braking force to a steerable road wheel of the vehicle comprises alternately applying braking force to one and then to the other of two steerable road wheels of the vehicle.

5. A method as set forth in claim 1 wherein the step of applying braking force to a steerable road wheel of the vehicle comprises applying braking force in an amount that is not sufficient to cause a significant departure from the path of the vehicle.

6. A method as set forth in claim 1 wherein the step of applying braking force to a steerable road wheel of the vehicle comprises applying braking force in an amount that is sufficient to cause a significant departure from the path of the vehicle.

7. A method as set forth in claim 6 wherein the step of applying braking force in an amount that is sufficient to cause a significant departure from the path of the vehicle comprises applying braking force in a manner to counter the lane departure.

8. A method as set forth in claim 1 wherein the step of applying braking force to a steerable road wheel of the vehicle comprises transmitting force from the steerable road wheel to the vehicle steering wheel thereby to provide tactile feedback through the steering wheel.

9. Apparatus for providing tactile feedback to a driver of a vehicle having left and right steerable road wheels and a steering wheel for controlling the steerable road wheels, the braking system comprising:
a left brake associated with the left steerable road wheel;
a right brake associated with the right steerable road wheel;
a lane departure sensor; and
an electronic control unit operatively connected with the lane departure sensor, the electronic control unit being operable to apply one of the left and right brakes in response to sensing an unintended lane departure of the vehicle without driver input.

10. Apparatus as set forth in claim 9 wherein:
the lane departure sensor is operative to sense the direction of lane departure; and
the ECU is operative to apply braking force to a selected steerable road wheel to counter the direction of lane departure.

11. Apparatus as set forth in claim 9 wherein the ECU is operative to apply braking force alternately to one and then to the other of the two steerable road wheels of the vehicle.

12. Apparatus as set forth in claim 9 wherein the ECU is operative to apply braking force in an amount that is not sufficient to cause a significant departure from the path of the vehicle.

13. Apparatus as set forth in claim 9 wherein the ECU is operative to apply braking force in an amount that is sufficient to cause a significant departure from the path of the vehicle.

14. Apparatus as set forth in claim 13 wherein the ECU is operative to apply braking force in an amount that is sufficient to cause a significant departure from the path of the vehicle so as to counter the lane departure.

15. Apparatus usable in a vehicle braking system for providing tactile feedback to a driver of a vehicle having a steering wheel and left and right steerable road wheels, the apparatus comprising:
a lane departure sensor; and
an electronic control unit operatively connected with the lane departure sensor, the electronic control unit providing a control signal for controlling the vehicle brakes in response to sensing an unintended lane departure of the vehicle without driver input.

16. Apparatus as set forth in claim 15 wherein the vehicle has a left brake associated with the left steerable road wheel and a right brake associated with the right steerable road wheel and a brake pedal operable by a driver of the vehicle for applying the left and right brakes;
the electronic control unit being operable to apply a selected one of the left and right brakes in response to sensing an unintended lane departure of the vehicle.

17. Apparatus as set forth in claim 16 wherein the lane departure sensor is operative to sense the direction of lane departure and the ECU is operative to apply braking force to a selected steerable road wheel to counter the direction of lane departure.

18. Apparatus for providing a lane departure warning to a vehicle driver through tactile feedback in the vehicle steering wheel, the apparatus comprising:
means for sensing an unintended lane departure of the vehicle; and
means responsive to the means for sensing for applying braking force to a steerable road wheel of the vehicle, thereby to provide tactile feedback through the steering wheel.

19. Apparatus as set forth in claim 18 wherein the means for sensing an unintended lane departure of the vehicle comprises a lane departure sensor.

20. Apparatus as set forth in claim 18 wherein the means for applying braking force to a steerable road wheel of the vehicle comprises an electronic control unit that is operative to provide a control signal to the vehicle braking system

21. Apparatus as set forth in claim 20 wherein the vehicle has a left brake associated with a left steerable road wheel and a right brake associated with a right steerable road wheel and a brake pedal operable by a driver of the vehicle for applying the left and right brakes;
the electronic control unit being operable to apply a selected one of the left and right brakes in response to sensing an unintended lane departure of the vehicle.
